(19) United States
(12) Patent Application Publication
(10) Pub. No.: US 2016/0330989 A1
(43) Pub. Date: Nov. 17, 2016

(54) DAIRY PRODUCTS WITH REDUCED ELECTROLYTES AND SYSTEMS AND METHODS OF MAKING SAME

(71) Applicant: LAND O'LAKES, INC., Arden Hills, MN (US)

(72) Inventors: Arti Bedi, Plymouth, MN (US); Kang Hu, Shoreview, MN (US)

(21) Appl. No.: 14/708,783

(22) Filed: May 11, 2015

(51) Int. Cl. A23C 9/142

(52) U.S. Cl. CPC A23C 9/1425

(57) ABSTRACT

Dairy products with reduced electrolytes, such as milk products with reduced electrolytes, are provided that contain potassium at less than 70 mg/100 g. Production involves subjecting a starting milk composition to ultrafiltration (UF) to provide a UF retentate and a UF permeate. The UF permeate, containing a high monovalent ion, multivalent ion and lactose content, is pH-adjusted to at least about 7.0. The pH-adjusted UF permeate is subjected to nanofiltration (NF) to provide a NF retentate with a reduced monovalent ion content. One or more NF cycles may be performed. The UF retentate and the NF retentate are combined to provide a dairy product with a reduced monovalent ion content that contains a substantial portion of solids, lactose, and divalent and multivalent ions from the starting milk product.

### TECHNICAL FIELD

The present disclosure relates to dairy products with reduced electrolytes and systems and methods for their production. More particularly, the present disclosure relates to dairy products with reduced monovalent ions, such as potassium, and systems and methods for their production.

### BACKGROUND

Electrolytes refer to minerals such as calcium, chloride, magnesium, phosphate, potassium, and sodium. Electrolytes are present in blood and body fluids and are necessary for normal bodily functions. Dairy and dairy-based products contain several electrolytes including calcium, phosphate, potassium, sodium and chloride.

Milk and other dairy-based products also provide an important source of nutrients, most notably protein and fat. Many consumers prefer milk and dairy-based products over non-dairy-based milk substitutes.

Potassium which is naturally present in whole milk at about 132 mg/100 g of milk, and can be as high as 155 mg/100 g of milk in skim milk. However, some consumers, while preferring milk and/or dairy-based products, require reduced levels of potassium in their diet, which requires that the consumer refrain from ingesting such products.

### SUMMARY

The present disclosure addresses the aforementioned issues by providing dairy products having selectively reduced electrolytes (e.g., potassium, sodium, and/or chloride) and systems and methods for their production. This may provide consumers with an opportunity to use these products instead of non-dairy-based milk substitutes, e.g., soy milk, rice milk and products derived from these substitutes, while at the same time delivering a similar or same aroma, taste, texture and experience of products derived from regular dairy milk. In addition, dairy-based products such as yogurt, cheese, ice cream and pudding may incorporate the reduced electrolyte milk without reducing consumer acceptability.

According to certain implementations, a method of producing a dairy product involves subjecting a starting milk composition to ultrafiltration (UF) to provide a UF retentate and a UF permeate, where the UF retentate contains a high solids content (proteins and fat) and the UF permeate contains a high monovalent ion, divalent ion, multivalent on and lactose content. The method proceeds by adjusting a pH of the UF permeate to at least about 7.0; subjecting the pH-adjusted UF permeate to at least two cycles of nanofiltration (NF) to provide a NF retentate with a reduced monovalent on content; adjusting a pH of the NF retentate to a pH equal to that of the starting milk composition; and combining the UF retentate and the pH-adjusted NF retentate to provide a dairy product with a reduced monovalent on content. The dairy product contains a substantial portion of solids, lactose, divalent ions and multivalent ions from the starting milk product.

In certain variations and alternatives, the NF retentate may be subjected to at least one cycle of diafiltration prior to one of the at least two NF cycles. In addition or alternatively, the combined UF and NF retentate may be subjected to one or more of UF or NF to provide the dairy product with desired solid content; the pH of the UF permeate may be adjusted to up to about 7.5; the pH of the NF retentate may be adjusted to about 6.3 to about 61; and/or a level of potassium in the dairy product may be reduced by at least about 60 percent relative to the starting milk composition.

In alternative implementations, a method of producing a dairy product involves subjecting a starting milk composition to ultrafiltration (UF) to provide a UF retentate and a UF permeate, where the UF retentate contains a high solids content and the UF permeate contains a high content of monovalent ions, divalent ions, multivalent ions and lactose. The method continues by adjusting a pH of the UF permeate to at least about 7.0; subjecting the pH-adjusted UF permeate to nanofiltration (NF) to provide a NF retentate with a reduced monovalent on content; and combining the UF retentate and the NF retentate to provide a dairy product with a reduced monovalent on content. The dairy product may contain a substantial portion of solids, lactose, divalent ions and multivalent ions from the starting milk product.

In certain variations and alternatives, the step of subjecting the pH-adjusted UF permeate to NF involves subjecting to at least two NF cycles. The NF retentate may be further subjected to at least one cycle of diafiltration prior to one of the at least two NF cycles. In addition or alternatively, a pH of the NF retentate may be adjusted to below about 6.7, or equivalent to the pH of the UF retentate, prior to the step of combining the UF retentate and the NF retentate; a total solids content of the combined UF and NF retentate may be adjusted, and if so, the combined UF and NF retentate may be subjected to one or more of UF or NF; the monovalent ions may include one or more of potassium, sodium or chloride ions; and/or a level of potassium in the dairy product may be reduced by at least about 50 percent relative to the starting milk composition.

In yet further implementations, a milk product contains potassium at less than 70 mg/100 g.

In certain variations and alternatives, the milk product is one of skim milk, whole milk, or reduced-fat milk. In addition or alternatively, the milk product further contains a nutrient profile of one of skim milk, whole milk, or reduced-fat milk.

### BRIEF DESCRIPTION OF THE DRAWINGS

FIG. 1 illustrates method for the selective removal of electrolytes from starting milk compositions.

### DETAILED DESCRIPTION

Implementations provide systems and methods for selectively removing electrolytes from starting milk compositions, and milk compositions having reduced electrolytes (i.e., ions).

In prior approaches such as U.S. Pat. No. 4,205,090, (Maubois et al.) where only ultrafiltration was used for ion depletion of dairy products, lactose was also removed during the process, resulting in significant change of milk composition, as well as the taste and mouth feel. When only nanofiltration is used for ion depletion, a large amount of diafiltration water needs to be added to milk to remove sufficient ions. This results in the protein and fat in milk being diluted which may result in changing the colloid structure of casein micelle during concentrating steps. In addition, ultrafiltration may result in removal of all ions including calcium and phosphorous, which may be undesirable due to the loss of desirable minerals with nutritional benefits. According to the present disclosure, ultrafiltration and nanofiltration processes may be used in combination to selectively remove the electrolytes from milk products while retaining other native milk components such as calcium, phosphorous, fat, protein and lactose. The selective removal of electrolytes involves separation of monovalent ions from divalent and multivalent ions present in the milk composition.

According to certain implementations, producing dairy products with reduced monovalent ions involves the reduction of potassium, sodium and/or chloride. Ultrafiltration, nanofiltration and/or diafiltration of milk compositions may be used to remove at least a portion of these monovalent ions naturally present in the milk, thereby reducing the electrolyte content. The resulting reduced electrolyte composition may contain at least 50 percent less of at least one of sodium, potassium or chloride compared to the starting milk composition. For instance, a milk product with reduced electrolytes, e.g., potassium (K) and sodium (Na), derived from skim milk may include substantially the same solids, protein, lactose and pH as compared to skim milk produced according to traditional methods. Table 1 illustrates a milk product having a reduced electrolyte content compared to the starting skim milk composition.

TABLE 1
Nutrient profile of Skim Milk and Reduced Electrolyte Milk

| | Skim | Reduced |
|---|---|---|
| | Milk | Electrolyte |
| Solids (wt %) | 9 | 8.4 |
| Protein (wt %) | 3.3 | 3.3 |
| pH | 6.5 | 6.5 |
| Lactose (wt %) | 4.9 | 4.8 |
| Ca (mg/100 g) | 121 | 120 |
| K (mg/100 g) | 155 | 66.7 |
| Na (mg/100 g) | 50 | 21.5 |
| Volume (Liters) | 4 | 4 |

As shown in Table 1, a milk product may contain potassium at less than 70 mg/100 g. While skim milk is used as an exemplary starting milk composition in Table 1, it will be understood that milk products may be produced with substantially the same nutrient profile, e.g., solids, protein, lactose, calcium, and pH as compared to other starting milk compositions according to the present disclosure. Such starting milk compositions may include, but are not limited to: whole milk (e.g., 4 percent fat), low-fat milk (e.g., 2 percent fat), low-lactose or lactose-free milk, previously ultrafiltered milk, diafiltered milk, microfiltered milk, or milk reconstituted from milk powder or a combination of these. Such starting milk compositions may contain all or a portion of the electrolytes naturally occurring in whole milk. For instance, low fat milk may contain about 2 percent fat by weight, about 7-12 percent total solids by weight, and the same calcium, potassium, sodium and lactose content as skim milk provided above in Table 1. In addition, while the reduced electrolyte milk product of Table 1 includes a reduced sodium content relative to the starting milk composition, the milk product may be fortified with this mineral prior to packaging in order to provide the milk product with a similar level of sodium compared to the starting milk composition. For instance, such a milk product may contain a nutrient profile that is substantially the same as skim milk, whole milk, reduced-fat milk or cream with the exception of a reduced monovalent on content for at least one monovalent on (e.g., potassium).

The milk products and dairy-based products (e.g., yogurt and cheese) with selectively reduced electrolytes (e.g., potassium, sodium, and/or chloride) provide consumers with an opportunity to use these products as a replacement for milk compositions (e.g., traditional whole milk, skim milk or reduced-fat milk) instead of non-dairy-based milk substitutes and food products made therefrom. In some implementations, a lactose content and/or calcium content of the milk product may be slightly lower than the starting milk composition without negatively affecting the flavor properties of the milk product.

Implementations use filtration, such as ultrafiltration and nanofiltration, to remove monovalent ions in permeate and retain divalent and multivalent ions including calcium as well as fat, protein and lactose. Nanofiltration membranes are typically surface charged, which may strongly repel divalent and multivalent ions, and partially allow monovalent ions to pass through to the permeate. Thus, using one, two or more nanofiltration steps may be preferred so that sufficient monovalent ions can be removed. Because nanofiltration membranes typically have a surface charge, particularly when the feed has a neutral pH (e.g., about 6.0 to 8.0), the majority of the divalent and multivalent ions are retained during the nanofiltration steps. Therefore, selecting charged nanofiltration membranes with certain pore size allows calcium, other divalent ions, multivalent ions and solids (e.g., lactose, protein and/or fat) to be retained in the retentate. Because many starting milk compositions have a natural pH of about 6.3 to about 6.7, the pH may be adjusted upward prior to filtration to increase the membrane electrostatic force and improve the ability of the membrane to repel the divalent and multivalent ions and prevent them from passing through to the permeate. The results of subjecting 2 percent fat milk to nanofiltration are illustrated in Table 2. In this example, the pH of the milk was 6.5.

TABLE 2
Nutrient profile of 2 percent milk before and after nanofiltration

| | | Total | | | | Lac- |
|---|---|---|---|---|---|---|
| | Fat, | solids, | Ca, | K, | Na, | tose, |
| | wt % | wt % | mg/100 g | mg/100 g | mg/100 g | wt % |
| 2% milk | 1.96 | 11.5 | 121 | 155 | 38.7 | 4 |
| NF Retentate | 1.89 | 7.41 | 112 | 48.3 | 11.7 | 1.68 |
| Depleted, % | 4 | 35.6 | 7.4 | 69 | 70 | 58 |

As shown in Table 2, the nanofiltration retentate retained much of the fat and protein (as reflected by total solids retained) and calcium (over 90 percent), while about 70 percent of the sodium and potassium were removed in the permeate. The majority of the reduction of total solids is due to the removal of lactose (about 60 percent of lactose), and this can be adjusted by selecting nanofiltration membrane pore size or molecular weight cut-off.

In some implementations, the retentate from nanofiltration may provide a milk product. In addition or alternatively, the retentate may be further processed. For instance, the retentate may be combined with the retentate of ultrafiltration and then subjected to further filtration steps, such as further nanofiltration, ultrafiltration or diafiltration steps.

In additional or alternative implementations, the material to be nanofiltered may be the permeate of ultrafiltration. For instance, the lactose in an ultrafiltration permeate may be separated from at least a portion of the monovalent ions by nanofiltration that allows monovalent ions (e.g., potassium, sodium and chloride) to pass to the permeate, while retaining lactose and divalent and multivalent ions in the retentate such that the retentate from the nanofiltration step may be combined with the retentate of the ultrafiltration step in order to provide a product with a reduced monovalent ion content. In this example, the retentate from the nanofiltration step may be further filtered using the various types of filtration disclosed herein prior to combining with the retentate of ultrafiltration.

In some implementations, diafiltration may be used as a washing step between nanofiltration cycles in order to remove a greater portion of monovalent ions in the permeate. Diafiltration using pure water, which could be deionized water or reverse osmosis water, may result in the pH change of the retentate. Thus, adjusting the retentate to a neutral pH may facilitate downstream nanofiltration cycles in the retention of divalent and multivalent ions in the retentate. While any of the monovalent ions present in milk may be selectively removed using the methods of the present disclosure, the selective removal of potassium may be preferred in order to provide a milk product with reduced potassium levels.

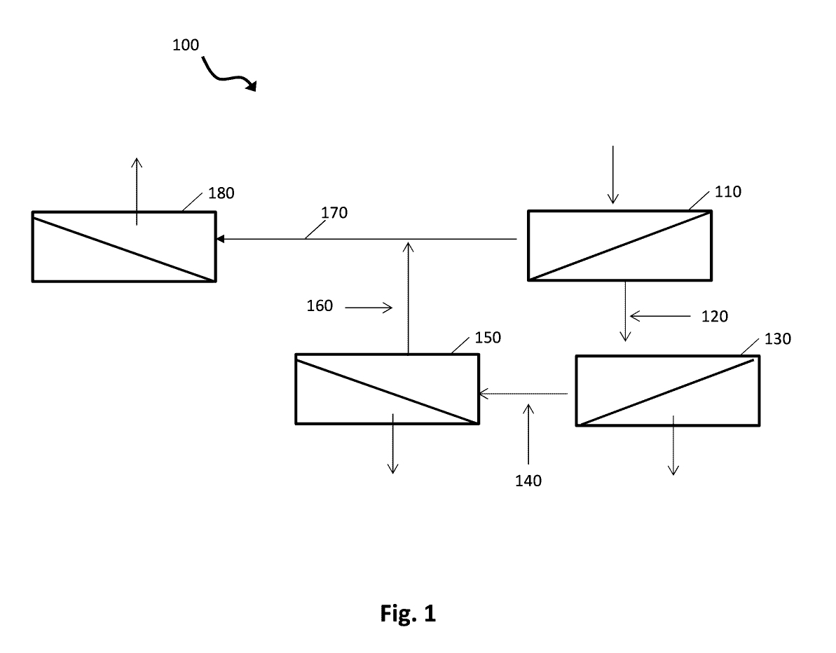

The milk compositions of the present disclosure may be produced by method 100 of FIG. 1, which illustrates a series of filtration steps that may be used for the selective removal of electrolytes from starting milk compositions. It should be noted that the diagonal line illustrated in the boxes of FIG. 1 divides each box into an upper portion and a lower portion, and the feed exiting the upper portion represents a retentate of the filtration step, while the feed exiting the lower portion represents a permeate of the filtration step.

According to FIG. 1, the method 100 starts by subjecting a starting milk composition to filtration in step 110. The starting milk composition may be any milk or milk-based composition including those described in the present disclosure. Step 110 may be any type of filtration step (e.g., ultrafiltration or nanofiltration) that separates a substantial portion of the total solids from ions, preferably monovalent ions, naturally present in milk. Ultrafiltration (UF) may be the preferred type of filtration in step 110 because UF membranes can be used to retain a large portion of total solids. Retention of solids in the retentate can improve the efficiency of subsequent filtration processes of the permeate, for instance, by conducting subsequent filtration steps at lower pressure and providing higher permeate flux relative to nanofiltration due to the reduced osmotic pressure.

The filtration step 110 provides a retentate with a high total solids content, which may include substantially all of the fat and protein from the starting milk composition. In addition, a majority of calcium ions that bond with protein may be concentrated in the retentate. The retentate may contain about 25 percent of the feed volume while the permeate may contain the remainder. The permeate may be low in total solids and may be rich in lactose, potassium, sodium, chloride and soluble calcium and phosphorous. For instance, up to 75 percent of these components may be removed to the permeate relative to levels in the starting milk composition. Particularly, lactose and dissolved ovalent ions (e.g., sodium, potassium and chloride) and divalent and multivalent ions (e.g., calcium and phosphorous) pass through the filtration membrane, e.g., UF membrane, into the permeate with little or no retention.

The step 110 may be conducted at low temperature, such as about 50 to 70° F., or at high temperature, such as 120 to 130° F. Processing at low temperatures may improve the flavor of the final milk product. Higher temperature processing, however, can reduce the membrane area for the production, resulting in lower capital investment. A membrane used may be a spiral wound or tubular configuration. For a UF membrane, the molecular weight cut-off of the membrane may be from 5K to 20K Dalton, and may preferably be 10K Dalton. In a batch process, a volume reduction ratio of 4 may be achieved by this initial filtration step and, for instance, all or substantially all proteins and fat from the starting milk composition may be concentrated four times.

In step 120, the permeate resulting from the filtration step 110 may optionally be pH-adjusted to about 7.0 to about 8.0. Starting milk compositions typically have a pH of about 6.3 to about 6.7, and adjusting the pH of the permeate slightly higher (e.g., about 7.5) may facilitate the retention of divalent and multivalent ions in subsequent filtration steps. For instance, sodium hydroxide (NaOH) may be added to increase the pH of the starting milk product to about 7.0 to about 7.5. Particularly, filtration membranes such as NF membranes are typically negatively charged, and increasing the pH of the feed solution results in a higher electrostatic force that can repel divalent and multivalent ions, meaning such ions may be retained at a higher rate in the retentate. As a consequence, divalent calcium ions, as well as other multivalent ions such as phosphorous, can be retained in subsequent filtration steps while allowing monovalent ions such as sodium and potassium to pass through the membrane to the permeate.

In step 130, the retentate may be subjected to filtration. Step 130 may be any type of filtration that separates the divalent and multivalent ions and lactose from the monovalent ions present in the permeate. Nanofiltration (NF) may be the preferred type of filtration in step 130 because NF membranes can be used to selectively retain divalent and multivalent ions while allowing monovalent ions to pass to the permeate. The volume reduction ratio of filtration step 130 may be 3. For instance, the final volume of this step is about ¼ of original volume of the original feed, and ⅓ of this volume forms the retentate and ⅔ forms the permeate. During step 130, more than half of the monovalent ions are removed in the permeate, and lactose and calcium are retained.

The filtration step 130 may be conducted at the same temperature as the filtration step 110, or may differ. The membrane used in filtration step may be configured with a high retention rate of divalent and multivalent ions and lactose and a low retention rate of monovalent ions. For instance, a membrane may be configured to retain 98.5 percent of lactose and 97.0 percent of divalent ions, and retain only about 20 percent of monovalent ions. In some implementations, a nanofiltration membrane may be used with a molecular weight cut off of 100 to 500 Dalton, preferably 300 to 500 Dalton.

Diafiltration (DF) may optionally be conducted in step 140 for the further removal of monovalent ions from the retentate resulting from step 130. For instance, water may be added to the retentate obtained from step 130. The volume of DF water added in step 140 can be up to 5 times of the retentate from step 130.

In step 150, the retentate obtained from step 130 or the DF mixture of step 140 may be subjected to filtration in order to further reduce the monovalent ion content of the retentate. Step 150 may be any type of filtration that separates the divalent and multivalent ions from the monovalent ions. Like step 130, NF may be the preferred type of filtration in step 150. The membrane used in step 150 may be the same as the membrane used in step 130. In step 150, the volume reduction ratio may be controlled so that the final volume is about 75 percent of the original volume of whole milk or skim milk. Following the filtration step 150, a majority of at least the potassium is removed relative to the level of potassium in the permeate produced in filtration step 110, and nearly all lactose and calcium are retained in the retentate of step 150.

In step 160, the pH of the retentate resulting from the filtration step 150 may optionally be adjusted to the pH of the starting milk composition. For instance, the pH may be adjusted using hydrochloric acid (HCl). The two pH adjustments at 120 and 160 may replenish the sodium and chloride content of the retentate that was otherwise lost during the two filtration steps 130 and 150 that targeted the removal of monovalent ions. In addition or alternatively, sulfuric acid (H₂SO₄) may be used to adjust the pH of the retentate where it is desirable to have a low chloride content in the milk product.

The retentate of the filtration step 110 and the retentate of the filtration step 150 may be combined in step 170 to provide a milk product with a similar composition as the starting milk composition except that a portion of the monovalent ions present in the original composition are removed. In some implementations, the milk product may be pH adjusted to the pH of the starting milk composition, for instance, when the retentate of the filtration step 150 is pH-adjusted prior to combining in step 170. In some implementations, the milk product may not be pH adjusted to the pH of the starting milk composition, for instance, when the retentate of the filtration step 150 is not pH-adjusted prior to combining in step 170. Then the milk product may have a pH of about 7.

The milk product produced in step 170 may optionally be subjected to a filtration step 180. For instance, if the volume of the product is higher than the original volume of the starting milk composition, then the total solids may be lower than the starting composition, and filtration step 180 may be used to concentrate the product. The desired retentate of this step may have a similar composition as the starting milk composition except that monovalent ions are substantially removed. Step 180 may be any type of filtration that retains solids and/or divalent ions and/or multivalent ions while allowing monovalent ions to pass to the permeate. For instance, step 180 may be an UF step or a NF step. In some implementations, the membranes used in filtration steps 110, 130 and 150 may be used in filtration step 180. In addition or alternatively, the milk product of step 170 may be subjected to heating to promote moisture loss.

With the process described in FIG. 1, about 50 percent of the potassium may be removed through removal of the permeates, for instance, in the filtration steps 130 and 150, while retaining a substantial portion of the other components in milk. To further deplete potassium or other monovalent ions from the milk product, the retentate of the filtration step 110, the retentate of filtration step 150, the milk product of step 170 and/or the retentate of step 180 may be subjected to additional filtration steps such as those described in FIG. 1.

The milk products produced by the methods of the present disclosure may be processed for packaging, distribution and end consumer use. For instance, the milk product may be concentrated to a total solids of about 40% and the stream may be spray dried to form the cheese product and/or powder product.

Filtration steps may be used to control the degree of ion depletion by controlling operating conditions such as pressure and diafiltration as will be understood by those skilled in the art. The use of membrane technology may result in a cleaner waste stream.

In alternative implementations, the starting milk composition may be pre-treated to remove a portion of the phosphate from the milk. For instance, a starting milk composition may be pH-adjusted to lower its pH and loosen the Ca-P bonds naturally present in milk. Subjecting the pH-adjusted composition to filtration may remove a portion of the phosphate.

While the methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations should not be construed as limiting.

Similarly, it should be appreciated that in the foregoing description of example embodiments, various features are sometimes grouped together in a single embodiment, figure, or description thereof for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

While the present disclosure has been particularly shown and described with reference to embodiments thereof, it will be understood by those skilled in the art that various other changes in the form and details may be made without departing from the spirit and scope of the disclosure.

What is claimed is:

1. A method of producing a dairy product, comprising the steps of:
subjecting a starting milk composition to ultrafiltration (UF) to provide a UF retentate and a UF permeate, wherein the UF retentate contains a high solids content and the UF permeate contains a high monovalent ion, divalent ion, multivalent ion and lactose content;
adjusting a pH of the UF permeate to at least about 7.0;
subjecting the pH-adjusted UF permeate to at least two cycles of nanofiltration (NF) to provide a NF retentate with a reduced monovalent ion content;
adjusting a pH of the NF retentate to a pH equal to that of the starting milk composition;
combining the UF retentate and the pH-adjusted NF retentate to provide a dairy product with a reduced monovalent ion content, wherein the dairy product contains a substantial portion of solids, lactose, divalent ions and multivalent ions from the starting milk product.

2. The method of claim 1, further comprising subjecting the NF retentate to at least one cycle of diafiltration prior to one of the at least two NF cycles.

3. The method of claim 1, further comprising subjecting the combined UF and NF retentate to one or more of UF or NF to provide the dairy product.

4. The method of claim 1, wherein the pH of the UF permeate is adjusted to up to about 7.5.

5. The method of claim 1, wherein the pH of the NF retentate is adjusted to about 6.3 to about 6.7.

6. The method of claim 1, wherein a level of potassium in the dairy product is reduced by at least about 60 percent relative to the starting milk composition.

7. A method of producing a dairy product, comprising the steps of:
subjecting a starting milk composition to ultrafiltration (UF) to provide a UF retentate and a UF permeate, wherein the UF retentate contains a high solids content and the UF permeate contains a high monovalent ion, divalent ion, multivalent ion and lactose content;
adjusting a pH of the UF permeate to at least about 7.0;
subjecting the pH-adjusted UF permeate to nanofiltration (NF) to provide a NF retentate with a reduced monovalent ion content; and
combining the UF retentate and the NF retentate to provide a dairy product with a reduced monovalent ion content, wherein the dairy product contains a substantial portion of solids, lactose, divalent ions and multivalent ions from the starting milk product.

8. The method of claim 7, wherein the step of subjecting the pH-adjusted UF permeate to NF comprises subjecting to at least two NF cycles.

9. The method of claim 8, further comprising subjecting the NF retentate to at least one cycle of diafiltration prior to one of the at least two NF cycles.

10. The method of claim 7, further comprising the step of adjusting a pH of the NF retentate to below about 6.7 prior to the step of combining the UF retentate and the NF retentate.

11. The method of claim 7, further comprising the step of adjusting a total solids content of the combined UF and NF retentate.

12. The method of claim 11, wherein the step of adjusting the total solids comprises subjecting the combined UF and NF retentate to one or more of UF or NF.

13. The method of claim 7, wherein the monovalent ions comprise one or more of potassium, sodium or chloride ions.

14. The method of clam 7, wherein a level of potassium in the dairy product is reduced by at least about 50 percent relative to the starting milk composition.

15. A milk product containing potassium at less than 70 mg/100 g.

16. The milk product of claim 15, wherein the milk product is one of skim milk, whole milk, reduced-fat milk or cream.

17. The milk product of claim 15, wherein the milk product further contains a nutrient profile of one of skim milk, whole milk, reduced-fat milk or cream.
